(19) United States
(12) Patent Application Publication
(10) Pub. No.: US 2016/0211067 A1
(43) Pub. Date: Jul. 21, 2016

(54) REACTOR DEVICE AND METHOD FOR MANUFACTURING REACTOR DEVICE

(71) Applicant: KABUSHIKI KAISHA TOYOTA JIDOSHOKKI, Kariya-shi, Aichi-ken (JP)

(72) Inventor: Tatsuya UEMATSU, Kariya-shi (JP)

(73) Assignee: KABUSHIKI KAISHA TOYOTA JIDOSHOKKI, Kariya-shi, Aichi-ken (JP)

(21) Appl. No.: 14/917,067

(22) PCT Filed: Sep. 5, 2014
(86) PCT No.: PCT/JP2014/073572

§ 371 Date: Mar. 7, 2016

(30) Foreign Application Priority Data
Sep. 10, 2013 (JP) 2013-187052

(51) Int. Cl. H01F 27/255; H01F 41/02; H01F 27/28

(52) U.S. Cl. CPC H01F 27/255; H01F 27/2823; H01F 41/0206

(57) ABSTRACT

A reactor includes a first core, a second core, and coils. The first core and the second core each include a plate-shaped base and two legs that extend from one plate surface of the base and are arranged in a layout direction. The legs of the first core are extended toward and spaced apart from the legs of the second core. Each of the bases includes narrow portions and a wide portion. The narrow portions are respectively arranged at two ends of the base in the layout direction. The narrow portions each include an end surface that is flush with a side surface of a corresponding one of the legs in a thickness-wise direction. The wide portion is arranged between the two narrow portions. The wide portion has a larger dimension in a widthwise direction than a maximum dimension of the legs in the widthwise direction.

### TECHNICAL FIELD

The present invention relates to a reactor device and a method for manufacturing a reactor device.

### BACKGROUND ART

Generally, a reactor device includes a core and coils that are wound around the core. Patent Document 1 discloses an example of a reactor device 200, which includes a core 201 and coils 204, as shown in FIGS. 7 and 8. The core 201 includes a plate-shaped base 202 and two legs 203, which extend from one plate surface of the base 202. The coils 204 are wound around the legs 203, respectively. The base 202 includes a tetragonal fixed width portion 205 and two curved portions 206, which are respectively arranged at the two longitudinal sides of the fixed width portion 205. The fixed width portion 205 has the same width as the diameter Wx of the cylindrical leg 203, which is the maximum width of the leg 203. The curved portions 206 each include a semicircular curved surface 206a.

### PRIOR ART DOCUMENT

### Patent Document

Patent Document 1: Japanese Laid-Open Patent Publication No. 2010-251364

### SUMMARY OF THE INVENTION

### Problems that are to be Solved by the Invention

A reactor device may need to be reduced in size. However, a reactor device having a reduced size is not preferred since this may result in loss when a sufficient magnetic path through which magnetic flux flows cannot be obtained.

Further, the heat dissipation efficiency of a reactor device may need to be improved. In this case, since the maximum width of the base 202 shown in FIGS. 7 and 8 is the same as the diameter Wx of the leg 203, axial end surfaces 204a of the coils 204 extend outward from the base 202 in the widthwise direction. Thus, the regions of the base 202 opposing the axial end surfaces 204a of the coils 204 are insufficient. Accordingly, the base 202 may not be able to absorb sufficient heat from the coils 204.

It is an object of the present invention to provide a reactor device that is reduced in size while obtaining a magnetic path and improves the heat dissipation efficiency and to provide a method for manufacturing the reactor device.

### Means for Solving the Problems

A reactor device that achieves the above object includes a first core, a second core, and coils. The first core and the second core each include a plate-shaped base and two legs that extend from one plate surface of the base and are arranged in a layout direction. The first core and the second core are arranged so that the legs of the first core are extended toward and spaced apart from the legs of the second core. Each of the coils is wound around a corresponding one of the legs of the first core and a corresponding one of the legs of the second core. Each of the bases includes narrow portions and a wide portion. The narrow portions are respectively arranged at two ends of the base in the layout direction. The narrow portions each include an end surface that is flush with a side surface of a corresponding one of the legs in a thickness-wise direction of the base. The wide portion is arranged between the two narrow portions. The wide portion has a larger dimension in a widthwise direction orthogonal to the thickness-wise direction and the layout direction than a maximum dimension of the legs in the widthwise direction.

In a method for manufacturing a reactor device that achieves the above object, the reactor device includes a first core, a second core, coils, and a box-shaped case having a closed end that accommodates the first core, the second core, and the coils. The method includes preparing the first core and the second core, each including a plate-shaped base and two legs that extend from one plate surface of the base and are arranged in a layout direction. Each of the bases includes narrow portions and a wide portion. The narrow portions are respectively arranged at two ends of the base in the layout direction. The narrow portions each include an end surface that is flush with a side surface of a corresponding one of the legs in a thickness-wise direction of the base. The wide portion is arranged between the two narrow portions. The wide portion has a dimension in a widthwise direction orthogonal to the thickness-wise direction and the layout direction that is larger than a maximum dimension of the legs in the widthwise direction. The method further includes arranging the second core on a bottom surface of the case so that the legs of the second core extend upward, arranging each of the coils to encompass a corresponding one of the legs of the second core, and arranging the first core so that the legs of the first core are extended toward and spaced apart from the legs of the second core.

In a method for manufacturing a reactor device that achieves the above object, the reactor device includes a first core, a second core, coils, and a box-shaped case having a closed end that accommodates the first core, the second core, and the coils. The method includes preparing the first core and the second core, each including a plate-shaped base and two legs that extend from one plate surface of the base and are arranged in a layout direction, arranging the second core on a bottom surface of the case so that the legs of the second core extend upward, arranging each of the coils to encompass a corresponding one of the legs of the second core, and arranging the first core so that the legs of the first core are extended toward and spaced apart from the legs of the second core.

### BRIEF DESCRIPTION OF THE DRAWINGS

FIG. 1 is an exploded perspective view schematically showing a reactor device.

FIG. 2 is a cross-sectional view taken along line 2-2 in FIG. 1.

FIG. 3 is an exploded perspective view showing a first core, a second core, and gap plates.

FIG. 4 is a plan view showing the first core, the second core, and coils.

FIGS. 5A to 5G are schematic end views each showing a method for manufacturing the reactor device.

FIG. 6 is a plan view showing cores of another example.

FIG. 7 is a plan view showing the internal structure of a conventional reactor device.

FIG. 8 is a cross-sectional view taken along line 8-8 in FIG. 7.

### EMBODIMENTS OF THE INVENTION

One embodiment of a reactor device will now be described.

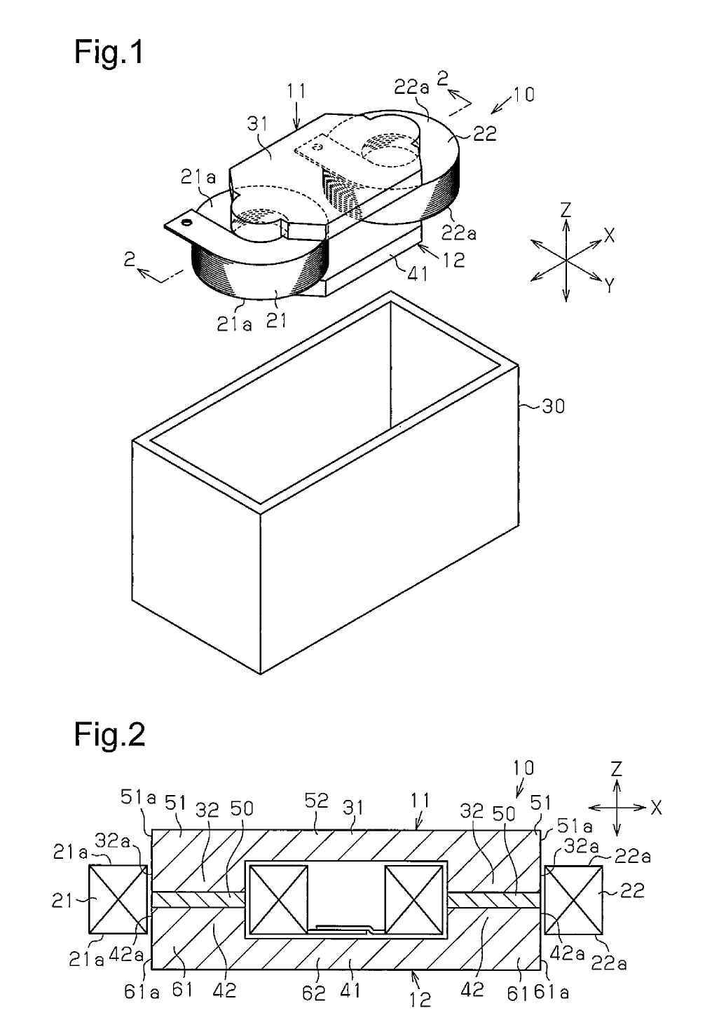

As shown in FIG. 1, a reactor device 10 includes a first core 11, a second core 12, coils 21 and 22, and a case 30, which is box-shaped and has a closed end. The case 30, which is formed from a heat-conductive material, accommodates the cores 11 and 12 and the coils 21 and 22.

Each of the cores 11 and 12 is a magnetic body formed from, for example, a powder magnetic core. The first core 11 and the second core 12 are identically shaped and opposed to each other.

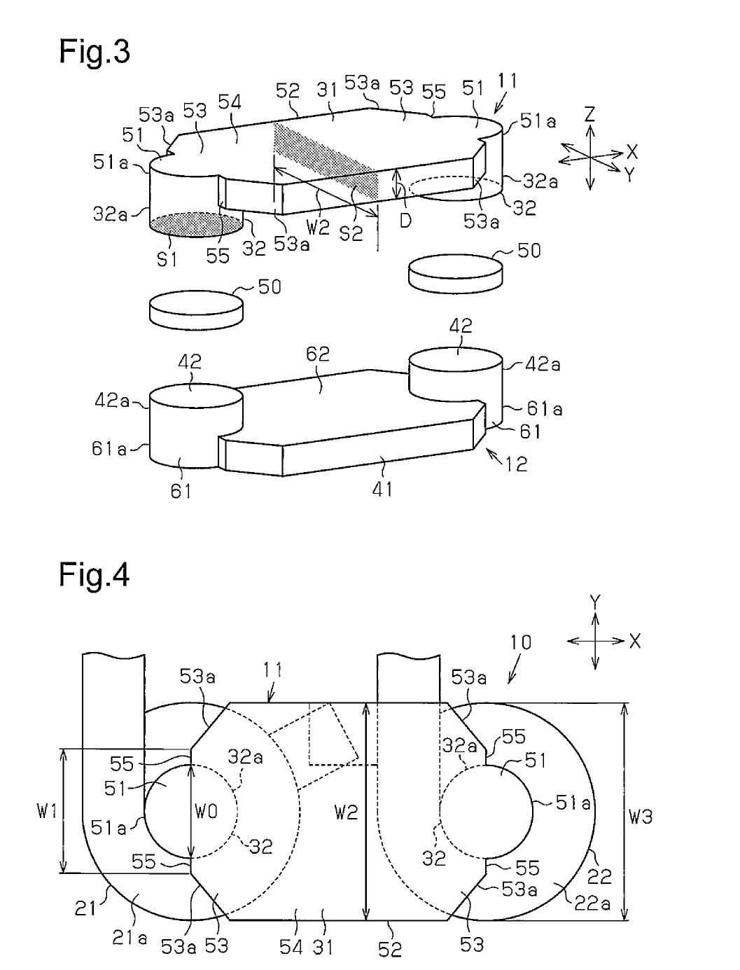

As shown in FIGS. 2 and 3, the first core 11 includes a plate-shaped first base 31 and two first legs 32, which extend from one plate surface of the first base 31, more specifically, extend from a plate surface located at the side of the second core 12. The two first legs 32 are laid out spaced apart from each other. The two first legs 32 oppose each other in the layout direction. Each of the first legs 32 is, for example, cylindrical.

The second core 12 includes a second base 41 and second legs 42 in the same manner as the first core 11. The second base 41 and the second legs 42 are shaped identically to the corresponding portions of the first core 11 and thus will not be described.

To assist understanding, the direction orthogonal to the thickness-wise direction Z of the bases 31 and 41 and the layout direction X of the two first legs 32 (or two second legs 42) are hereinafter referred to as the widthwise direction Y. The thickness-wise direction Z of the bases 31 and 41 is the extension direction of the legs 32 and 42.

As shown in FIGS. 2 and 3, the first core 11 and the second core 12 are arranged so that the first legs 32 and the second legs 42 are spaced apart from and opposed to each other in the thickness-wise direction Z. More specifically, the reactor device 10 includes two gap plates 50, which are arranged between the first legs 32 and the second legs 42. Each of the gap plates 50, which are formed from a non-magnetic body, is circular and has the same diameter as the legs 32 and 42. The gap plates 50 are adhered and fixed to the first legs 32 and the second legs 42. More specifically, each gap plate 50 is arranged between the corresponding first leg 32 and the corresponding second leg 42 that extend toward each other. Thus, the cores 11 and 12 are coupled so that the distance of the first legs 32 from the second legs 42 remains fixed.

As shown in FIG. 2, the coils 21 and 22 of the reactor device 10 are each wound around the corresponding first leg 32 and the corresponding second leg 42. Each of the coils 21 and 22 is an annular coil in which rectangular wires are wound in an edgewise manner. One end of the coil 21 is coupled to one end of the coil 22.

The reactor device 10 includes upper bobbins (not shown), which surround the first legs 32, and lower bobbins (not shown), which surround the second legs 42. The coils 21 and 22 are wound around the upper and lower bobbins, respectively. However, the upper and lower bobbins may be omitted.

The winding direction of the coil 21 differs from that of the coil 22. The coil 21 is wound in the counterclockwise direction as viewed from above, and the coil 22 is wound in the clockwise direction as viewed from above.

As shown in FIGS. 3 and 4, the first base 31 of the first core 11 includes narrow portions 51 and a wide portion 52 that have different widths (i.e., dimensions in widthwise direction Y). The narrow portions 51 are arranged at the two sides of the first base 31 in the layout direction X, respectively. The wide portion 52 is arranged between the two narrow portions 51. The first base 31 is shaped to be symmetrical in the layout direction X.

The first legs 32 each extend across the narrow portion 51 and the wide portion 52. More specifically, the outer half of the first leg 32 (semi-cylindrical portion) in the layout direction X is located in the narrow portion 51, and the inner half of the first leg 32 is located in the wide portion 52.

The narrow portions 51 each include an end surface 51a, which is flush with a side surface 32a of the first leg 32 in the thickness-wise direction Z of the first base 31. Since the first leg 32 is cylindrical as described above, the side surface 32a of the first leg 32 is curved. The end surface 51a of the narrow portion 51 is accordingly curved at the same curvature as the side surface 32a of the first leg 32. More specifically, the end surface 51a of the narrow portion 51 is a semicircular surface curved at the same curvature as the side surface 32a of the first leg 32.

As shown in FIG. 4, the maximum width W0 of the first leg 32 is the diameter of the first leg 32, and the maximum width WO is the maximum width of the narrow portion 51.

The wide portion 52, which has a larger width than the narrow portion 51, includes width enlarging portions 53 and a fixed width portion 54. The width enlarging portions 53 each gradually widen from the narrow portion 51 toward the middle part of the first base 31 in the layout direction X. The fixed width portion 54, which has a fixed width, is continuous with the width enlarging portions 53. As shown in FIG. 4, parts of the width enlarging portions 53 and part of the fixed width portion 54 oppose end surfaces 21a and 22a in the axial direction of the coils 21 and 22.

As shown in FIG. 4, in the present embodiment, a step surface 55 is formed between an end surface 53a, which extends in the widthwise direction Y of the width enlarging portion 53, and the end surface 51a of the narrow portion 51. The width of the wide portion 52 (width enlarging portion 53) is enlarged in a non-continuous manner from the width of the narrow portion 51. The minimum width W1 of the width enlarging portion 53 is larger than the maximum width WO of the first leg 32. That is, in the present embodiment, the wide portion 52 has a larger width at any location than the maximum width WO of the first leg 32. Further, the wide portion 52 has a larger width at any location than the inner diameter of each of the coils 21 and 22 that are wound around the first legs 32.

The fixed width portion 54 has the maximum width of the wide portion 52, and the width of the fixed width portion 54 corresponds to the maximum width W2 of the wide portion 52. The maximum width W2 is set to be greater than or equal to the maximum width W3 of each of the coils 21 and 22 (in the present embodiment, outer diameter of coils 21 and 22). In the present embodiment, the maximum width W2 of the wide portion 52 is set to be equal to the maximum width W3 of each of the coils 21 and 22.

As shown in FIG. 3, the cross-sectional area S1 of each first leg 32 in the direction orthogonal to the thickness-wise direction Z of the first base 31 is set to be equal to the cross-sectional area S2 of the fixed width portion 54 in the direction orthogonal to the layout direction X. More specifically, the thickness D of the first base 31 is set to be a value that is obtained by dividing the cross-sectional area S1 of the first leg 32 by the maximum width W2 of the wide portion 52.

The second base 41 of the second core 12 includes narrow portions 61 and a wide portion 62 in the same manner as the first base 31 of the first core 11. The narrow portions 61 each include an end surface 61a, which is flush with a side surface 42a of the second leg 42 in the thickness-wise direction Z of the second base 41. The wide portion 62 has a larger width than the narrow portions 61. The narrow portions 61 and the wide portion 62 are shaped identically to the narrow portions 51 and the wide portion 52 of the first base 31 and thus will not be described in detail. More specifically, the maximum width W0 and the cross-sectional area S1 of the first leg 32 are respectively equal to the maximum width W0 and the cross-sectional area S1 of the second leg 42, the thickness D of the first base 31 is equal to the thickness D of the second base 41, and the maximum width W2 of the wide portion 52 is equal to the maximum width W2 of the wide portion 62.

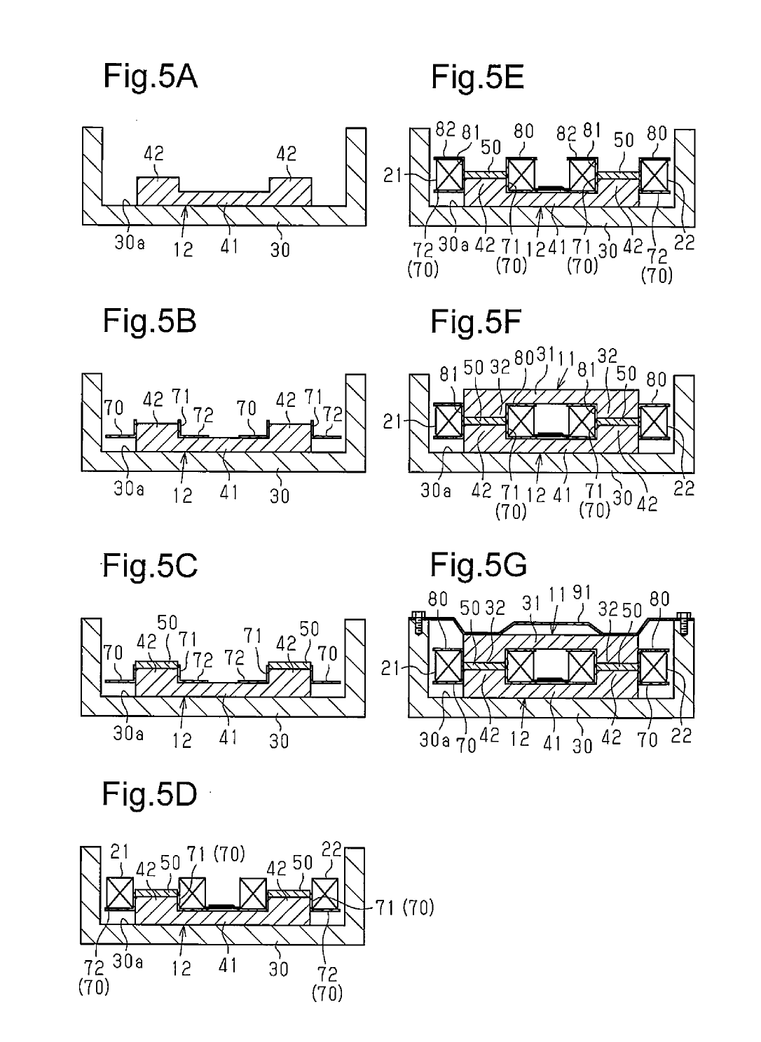

A method for manufacturing the reactor device 10 will now be described with reference to FIG. 5. FIG. 5 shows components that have not been described above such as bobbins 70 and 80.

As shown in FIG. 5A, the case 30, which is box-shaped and has a closed end, is first set so that the open end faces upward. The second core 12 is set on a bottom surface 30a of the case 30 so that the second legs 42 extend upward.

Before setting the second core 12, thermal grease may be applied to the location where the second core 12 is set. That is, the second core 12 may be directly set on the bottom surface 30a of the case 30 or indirectly set on the bottom surface 30a of the case 30 with thermal grease applied in between.

As shown in FIG. 5B, the lower bobbins 70, each of which includes a tube 71, are arranged so that the tubes 71 are fitted to the second legs 42. The inner diameter of the tubes 71 is slightly greater than or equal to the diameter of the second legs 42. Further, the lower bobbins 70 each include a flange 72, which radially extends from one axial end of the tube 71. As shown in FIG. 5C, after an adhesive (not shown) is applied to distal end surfaces of the second legs 42, the gap plates 50 are arranged on the distal end surfaces to adhere the second legs 42 and the gap plates 50.

As shown in FIG. 5D, the coils 21 and 22 are set respectively wound around the second legs 42. More specifically, the coils 21 and 22 are each arranged on the flange 72 of the corresponding lower bobbin 70. Subsequently, as shown in FIG. 5E, the upper bobbins 80 are set. The upper bobbins 80 are shaped identically to the lower bobbins 70 and each include a tube 81 and a flange 82. In this case, the upper bobbins 80 are arranged so that ends opposite to the ends of the tubes 71 and 81 of the bobbins 70 and 80 that include the flanges 72 and 82 come into contact with each other.

As shown in FIG. 5F, the first core 11 is arranged so that the first legs 32 of the first core 11 are spaced apart from and opposed to the second legs 42 of the second core 12. More specifically, after an adhesive is applied to the upper surfaces of the gap plates 50, the first legs 32 are set in contact with the upper surfaces of the gap plates 50. Thus, the coils 21 and 22 are each arranged encompassing the corresponding first leg 32 and the corresponding second leg 42 with the bobbins 70 and 80 (more specifically, tubes 71 and 81) located in between.

As shown in FIG. 5G, a leaf spring 91, which biases the first core 11, is set, and the leaf spring 91 is fastened to the case 30. Subsequently, the case 30 is filled with a heat-dissipating resin (not shown) that absorbs heat generated from the coils 21 and 22, and the heat-dissipating resin is hardened through a predetermined process such as heat treatment. In this manner, the reactor device 10 is manufactured.

The operation of the present embodiment will now be described.

The cores 11 and 12 are arranged so that the legs 32 and 42 oppose each other with the gap plates 50 located in between. This forms an annular magnetic path. In this case, the narrow portions 51 and 61 are respectively arranged at the two ends of the bases 31 and 41 of the cores 11 and 12 in the layout direction X. Thus, the first base 31 includes portions where magnetic flux smoothly flows, more specifically, portions that are continuous with the legs 32 and a portion that is located between the first legs 32. The first base 31 does not include portions where the flow of magnetic flux is unsmooth, for example, portions located at the outer sides of the first legs 32 in the layout direction X. In the same manner, the second base 41 includes portions where magnetic flux smoothly flows, more specifically, portions that are continuous with the legs 42 and a portion that is located between the second legs 42. The second base 41 does not include portions where the flow of magnetic flux is unsmooth, for example, portions located at the outer sides of the second legs 42 in the layout direction X.

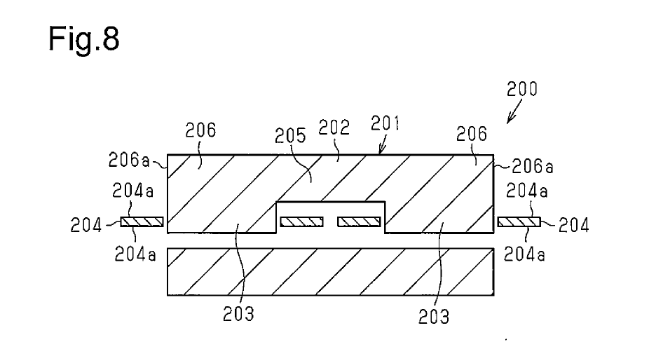

Further, the wide portion 52, which is wider than the maximum width W0 of the first leg 32, is located between the two narrow portions 51 of the first base 31. The wide portion 62, which is wider than the maximum width W0 of the second leg 42, is located between the two narrow portions 61 of the second base 41. Thus, in comparison with the conventional base 202 of FIGS. 7 and 8, the bases 31 and 41 include larger regions that oppose the end surfaces 21a and 22a in the axial direction of the coils 21 and 22.

The present embodiment has the advantages described below.

(1) The bases 31 and 41 of the cores 11 and 12 respectively include the narrow portions 51 and 61, which are arranged at the two sides in the layout direction X of the two first legs 32 (or two second legs 42). The narrow portions 51 and 61 respectively include the end surfaces 51a and 61a, which are flush with the side surfaces 32a and 42a of the legs 32 and 42 in the thickness-wise direction Z of the bases 31 and 41. Further, the first base 31 of the first core 11 includes the wide portion 52, which is located between the two narrow portions 51 and is wider than the maximum width W0 of the first leg 32. In the same manner, the second base 41 of the second core 12 includes the wide portion 62, which is located between the two narrow portions 61 and is wider than the maximum width W0 of the second leg 42. Thus, as compared with the conventional base 202 of FIG. 7, the thickness D of the bases 31 and 41 is reduced while obtaining a predetermined amount of the cross sections of the bases 31 and 41 in the direction orthogonal to magnetic flux. Accordingly, the reactor device 10 is reduced in size in the thickness-wise direction Z while obtaining a magnetic path.

Further, the bases 31 and 41 include larger regions that oppose the end surfaces 21a and 22a in the axial direction of the coils 21 and 22 than the conventional base 202. Thus, heat generated by the coils 21 and 22 is transmitted to the bases 31 and 41 in a favorable manner. This reduces the reactor device 10 in size while obtaining a magnetic path. This also improves the heat-dissipation efficiency of the reactor device 10.

In addition, the two ends of the bases 31 and 41 of the cores 11 and 12 in the layout direction X are the narrow portions 51 and 61. Thus, the bases 31 and 41 do not include portions where the flow of magnetic flux is unsmooth. This reduces the costs of the cores 11 and 12 while obtaining a magnetic path.

(2) The maximum width W2 of the wide portions 52 and 62 is larger than or equal to the maximum width W3 of the coils 21 and 22. Thus, since heat transmitted from the coils 21 and 22 to the wide portions 52 and 62 is diffused over wider regions than when the maximum width W2 is smaller than the maximum width W3, the heat is smoothly transmitted to the case 30. This improves the heat dissipation efficiency of the wide portions 52 and 62. As a result, the heat dissipation efficiency of the reactor device 10 is further improved.

(3) The cross-sectional area S1 of each of the legs 32 and 42 in the direction orthogonal to the thickness-wise direction Z is set to be equal to the cross-sectional area S2 of the widest portions of the wide portions 52 and 62 in the direction orthogonal to the layout direction X. This reduces the loss resulting from changes in the cross-sectional area of the magnetic path.

More specifically, the thickness D of each of the bases 31 and 41 is set to a value that is obtained by dividing the cross-sectional area S1 of each of the legs 32 and 42 by the maximum width W2 of the wide portions 52 and 62. Thus, the cross-sectional area S1 and the cross-sectional area S2 are equal. In this case, the maximum width W2 of each of the wide portions 52 and 62 is larger than the maximum width W0 of each of the legs 32 and 42. Thus, the thickness D of each of the bases 31 and 41 is smaller than the conventional base 202 although the cross-sectional area S1 and the cross-sectional area S2 are equal. Accordingly, the size of the reactor device 10 is further reduced in the thickness-wise direction Z.

(4) The wide portion 52 of the first base 31 includes the width enlarging portions 53, each of which gradually widens from the narrow portion 51 toward the middle part of the first base 31 in the layout direction X. Thus, the first core 11 does not include portions where the flow of magnetic flux is relatively unsmooth. This reduces the cost of the first core 11 while obtaining a magnetic path. The same applies to the second core 12.

(5) The reactor device 10 includes the cores 11 and 12, the coils 21 and 22, and the box-shaped case 30, which has a closed end and accommodates the cores 11 and 12 and the coils 21 and 22. The cores 11 and 12 respectively include the bases 31 and 41, which have the form of plates, and the two legs 32 and 42, which extend from one of the plate surfaces of the bases 31 and 41 and are arranged in the layout direction. The method for manufacturing the reactor device 10 having such a structure includes a process for setting the second core 12 on the bottom surface 30a of the case 30 so that the second legs 42 extend upward and a process for setting the coils 21 and 22 around the second legs 42 of the second core 12. Further, the method for manufacturing the reactor device 10 includes a process for arranging the first core 11 so that the first legs 32 of the first core 11 are extended toward and spaced apart from the second legs 42. In such a structure, the cores 11 and 12 are sequentially stacked in the case 30 to manufacture the reactor device 10. This simplifies and facilitates manufacturing of the reactor device 10.

More specifically, if the cores 11 and 12 and the coils 21 and 22 are first coupled and then the coupled components are accommodated in the case 30, an accommodation process needs to be performed to accommodate the coupled components in the case 30. This complicates the manufacturing of the reactor device 10. In addition, if the direction the cores 11 and 12 and the coils 21 and 22 are coupled differ from the direction the coupled components are accommodated in the case 30, an operation for changing directions needs to be performed. Further, the automation of a series of processes, such as a process for changing the direction of the case 30 and a process for coupling components in different directions, has a tendency to cause complicated manufacturing processes.

In the present embodiment, components are directly arranged in the case 30. Thus, the above accommodation process is omitted. Further, the components are sequentially stacked from bottom to top without changing directions. Thus, the processes of the method for manufacturing the reactor device 10 may be automated relatively easily.

The above embodiment may be modified as described below.

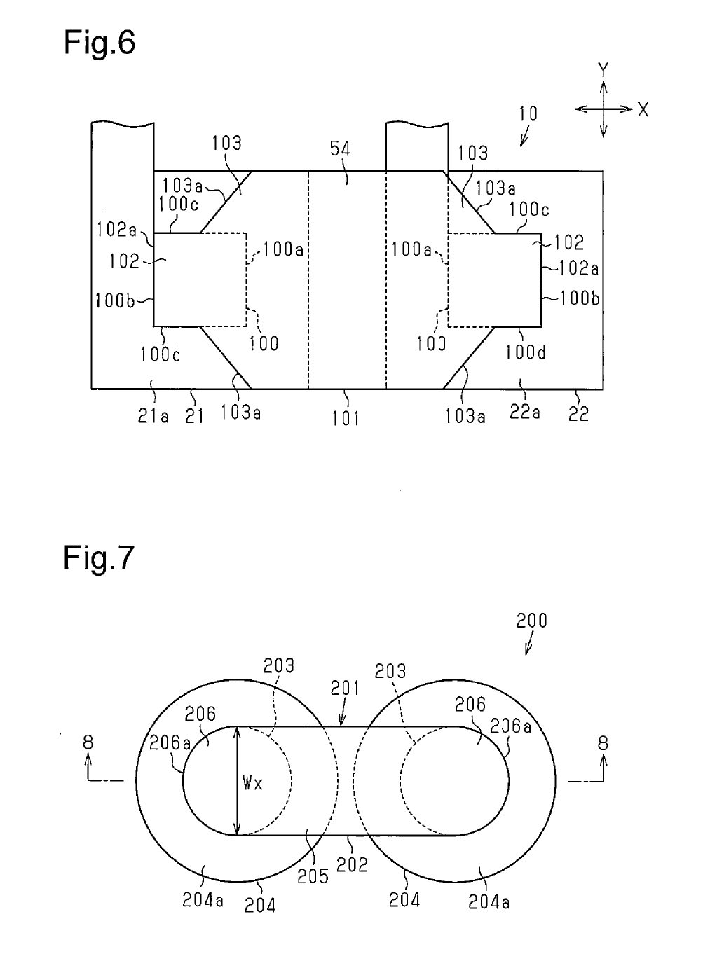

In the embodiment, each first leg 32 of the first core 11 is cylindrical and has a width that changes in accordance with location in the layout direction X. However, the first leg may have any form. For example, as shown in FIG. 6, a first leg 100 may be box-shaped and have a width that remains fixed regardless of location in the layout direction X. In this case, the maximum width of the first leg 100 simply refers to the width of the first leg 100. The first legs 100 each include a first side surface 100a, which faces the middle part of the first core 11, a second side surface 100b, which is arranged at the side opposite to the first side surface 100a, and a third side surface 100c and a fourth side surface 100d, which extend from the first side surface 100a to the second side surface 100b. End surfaces 102a of narrow portions 102 of a first base 101 may be respectively flush with the entire second side surfaces 100b of the first legs 100. The end surfaces 102a of the narrow portions 102 of the first base 101 may be respectively flush with parts of the third side surface 100c and the fourth side surface 100d. The same applies to the second core 12.

As shown in FIG. 6, end surfaces 103a in the widthwise direction Y of width enlarging portions 103 may be connected to the end surfaces 102a of the narrow portions 102 without the step surface 55 (refer to FIG. 4). Further, the narrow portion does not have to have a width in the layout direction X. For example, when the box-shaped first legs 100 are arranged, the width enlarging portions may be respectively extended to the two ends of the base in the layout direction X. In this case, portions of the two ends of the base in the layout direction X that are flush with the second side surfaces 100b correspond to the narrow portions.

The gap plates 50 may be omitted. In this case, the distance between the first leg 32 and the second leg 42 may be adjusted by adjusting the distance between the flanges 72 and 82 of the bobbins.

Fins may be arranged in at least part of the case 30 to increase the heat dissipation efficiency.

The coils 21 and 22 may be formed by winding round wires.

The maximum width W2 of the wide portions 52 and 62 may be set to be greater than the maximum width W3 of each of the coils 21 and 22.

Further, the maximum width W2 of each of the wide portions 52 and 62 may be set to be smaller than the maximum width W3 of each of the coils 21 and 22. As a result, the bases 31 and 41 do not extend outward from the coils 21 and 22 in the widthwise direction Y.

The width enlarging portions 53 may be omitted, and the wide portions 52 may entirely be the fixed width portion 54. This enlarges the regions of the first base 31 opposing the end surfaces 21a and 22a of the coils 21 and 22 in the axial direction. Thus, the heat dissipation efficiency is further improved. However, it is preferable that the width enlarging portions 53 be arranged for reducing costs such as material costs for the first core 11. The same applies to the second core 12.

More specifically, each wide portion may be shaped so that the width changes in accordance with location in the layout direction X or be shaped so that the width is fixed regardless of location in the layout direction X. When the wide portion is shaped to have a fixed width regardless of location in the layout direction X, the fixed width of the wide portion corresponds to the maximum width.

The end surfaces 51a and 61a of the narrow portions 51 and 61 are semicircular curved surfaces in which the angle of an arc is 90°. Instead, as long as the side surfaces 32a and 42a of the legs 32 and 42 have the same curvature, the angle may be smaller than 90°.

In the embodiment, the leaf spring 91 is arranged on the upper surface of the first core 11. Instead, a heat-transmitting member that transmits the heat generated from the first core 11 may be arranged. This further improves the heat dissipation efficiency.

1. A reactor device comprising:
a first core;
a second core; and
coils;
wherein
the first core and the second core each include:
a plate-shaped base; and
two legs that extend from one plate surface of the base and are arranged in a layout direction,
the first core and the second core are arranged so that the legs of the first core are extended toward and spaced apart from the legs of the second core,
each of the coils is wound around a corresponding one of the legs of the first core and a corresponding one of the legs of the second core, and
each of the bases includes:
narrow portions respectively arranged at two ends of the base in the layout direction, wherein the narrow portions each include an end surface that is flush with a side surface of a corresponding one of the legs in a thickness-wise direction of the base; and
a wide portion arranged between the two narrow portions, wherein the wide portion has a larger dimension in a widthwise direction orthogonal to the thickness-wise direction and the layout direction than a maximum dimension of the legs in the widthwise direction.

2. The reactor device according to claim 1, wherein a maximum dimension of the wide portion in the widthwise direction is greater than or equal to a maximum dimension of the coil in the widthwise direction.

3. The reactor device according to claim 1, wherein the leg has a cross-sectional area in a direction orthogonal to the thickness-wise direction that is the same as a cross-sectional area of the wide portion in a direction orthogonal to the layout direction at a location where a dimension in the widthwise direction is largest.

4. The reactor device according to claim 1, wherein
in each of the first core and the second core, the wide portion includes a width enlarging portion adjacent to at least one of the narrow portions, and
the width enlarging portion has a dimension in the widthwise direction that gradually increases from the at least one of the narrow portions toward a middle part of the base in the layout direction.

5. A method for manufacturing a reactor device, wherein the reactor device includes a first core, a second core, coils, and a box-shaped case having a closed end that accommodates the first core, the second core, and the coils, the method comprising:
preparing the first core and the second core, each including a plate-shaped base and two legs that extend from one plate surface of the base and are arranged in a layout direction, wherein each of the bases includes:
narrow portions respectively arranged at two ends of the base in the layout direction, wherein the narrow portions each include an end surface that is flush with a side surface of a corresponding one of the legs in a thickness-wise direction of the base; and
a wide portion arranged between the two narrow portions, wherein the wide portion has a dimension in a widthwise direction orthogonal to the thickness-wise direction and the layout direction that is larger than a maximum dimension of the legs in the widthwise direction;
arranging the second core on a bottom surface of the case so that the legs of the second core extend upward;
arranging each of the coils to encompass a corresponding one of the legs of the second core; and
arranging the first core so that the legs of the first core are extended toward and spaced apart from the legs of the second core.

6. A method for manufacturing a reactor device, wherein the reactor device includes a first core, a second core, coils, and a box-shaped case having a closed end that accommodates the first core, the second core, and the coils, the method comprising:
preparing the first core and the second core, each including a plate-shaped base and two legs that extend from one plate surface of the base and are arranged in a layout direction;
arranging the second core on a bottom surface of the case so that the legs of the second core extend upward;
arranging each of the coils to encompass a corresponding one of the legs of the second core; and
arranging the first core so that the legs of the first core are extended toward and spaced apart from the legs of the second core.
